(19) United States
(12) Patent Application Publication
(10) Pub. No.: US 2006/0191113 A1
(43) Pub. Date: Aug. 31, 2006

(54) Fastener for fastening tubular objects

(76) Inventor: Shih Chao Chin, Taichung City (TW)

Correspondence Address: CHARLES E. BAXLEY, ESQ., 90 JOHN STREET, THIRD FLOOR, NEW YORK, NY, 10038, US

(21) Appl. No.: 11/067,997

(22) Filed: Feb. 28, 2005

(51) Int. Cl. F16L 33/00

(52) U.S. Cl. 24/279

(57) ABSTRACT

A fastener includes a brace member with a screw rotatably extending therethrough and a belt having a plurality of positioning holes has one end extending through a first end of an extension portion on the brace member and the other end of the belt wraps around a tubular object and extends from a second end of the extension portion and is located between the first end of the belt and the screw. The positioning holes of the section end of the belt are engaged with the threads of the screw that when rotating the screw, the second belt is moved to fasten the tubular object. A driving member has a receiving port in which the protrusion of the screw is securely received.

### FIELD OF THE INVENTION

The present invention relates to a fastener with a collar, a screw and a driving member, wherein the screw includes a simple structure which is easily to be manufactured.

### BACKGROUND OF THE INVENTION

A conventional fastener for fastening a tubular object generally includes a belt with a plurality of positioning holes defined therethrough and one end of the belt extends through a brace member. The other end of the belt wraps around the tubular object and goes through the brace member. A screw rotatably extends into the brace member and the threads of the screw are engaged with the positioning holes in the belt. A driving end extends from the screw and beyond the brace member. A driving member is mounted to the driving end of the screw so as to rotate the screw to tighten the belt onto the tubular object. Nevertheless, the protrusion includes a complicated shape so that it requires a lot of time to manufacture this portion and this increase the manufacturing cost.

The present invention intends to provide a fastener wherein the protrusion is easily to be manufactured so as to simplify the processes for making the screw.

### SUMMARY OF THE INVENTION

The present invention relates to a fastener for tightening a tubular object and comprises a brace member having a screw rotatably extending from one end of the brace member. The brace member has an extension portion. The screw has a shoulder portion extending radially outward therefrom and a protrusion extends from the shoulder portion. The protrusion includes a first section and a second section which axially extends from the first section. The shoulder portion and the protrusion are located outside of the brace member.

A belt having a plurality of positioning holes has one end thereof extending through a first end of the extension portion and the other end of the belt extends from a second end of the extension portion and is located between the first end of the belt and the screw. The positioning holes are engaged with threads of the screw. A driving member has a receiving port which is composed of a recess and an enlarged opening defined in an end of the driving member. An outer diameter of the first section is larger than an outer diameter of the second section and an inner diameter of the recess. The outer diameter of the second section is larger than the inner diameter of the recess. The second section of protrusion is engaged with the recess and the first section of the protrusion is engaged with the enlarged opening of the driving member.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the brace member on a belt and a driving member of the fastener of the present invention;

FIG. 2 is a cross sectional view to show the brace member on a belt and a driving member of the fastener of the present invention;

FIG. 3 shows the second section of the screw is inserted in the receiving port of the driving member;

FIG. 4 shows the opening of the receiving port is enlarged by the first section of the protrusion, and

FIG. 5 shows the protrusion of the screw is completely engaged with the receiving port of the driving member.

### DETAILED DESCRIPTION OF THE PREFERRED EMBODIMENT

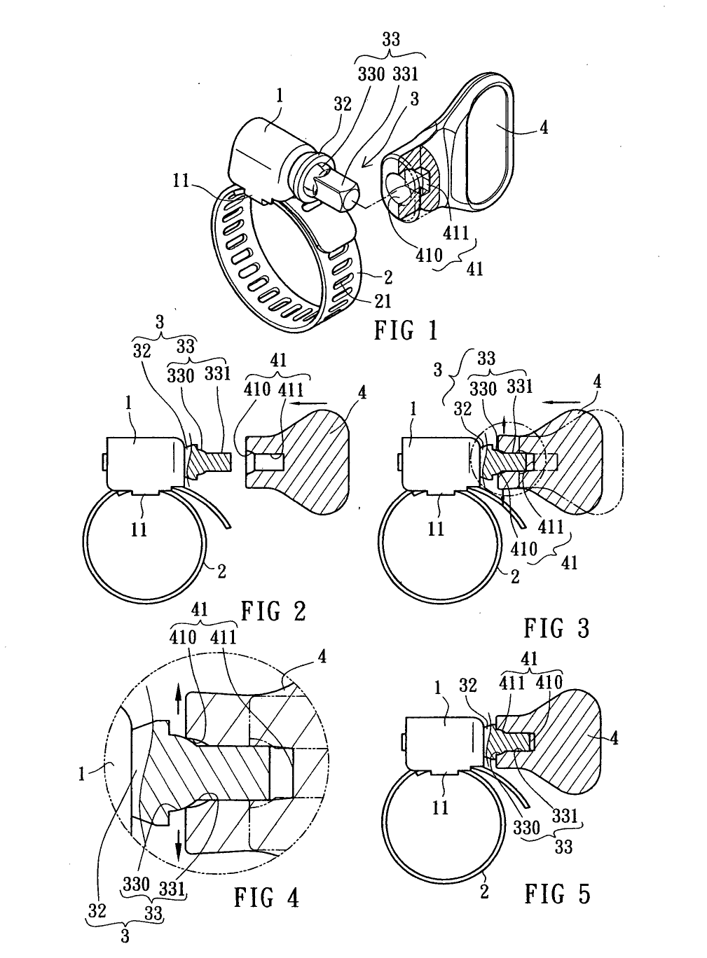

Referring to FIGS. 1 to 3, the fastener of the present invention comprises a brace member 1 having a screw 3 rotatably extending from one end of the brace member 1. The screw 3 has a shoulder portion 32 extending radially outward therefrom and a protrusion 33 extends from the shoulder portion 32. The protrusion 33 includes a first section 330 and a second section 331 which axially extends from the first section 330. The second section 331 has a rectangular cross section. The shoulder portion 32 and the protrusion 33 are located outside of the brace member 1.

A belt 2 has a plurality of positioning holes 21 defined therethrough. One end of the belt 2 extends through a first end of an extension portion 11 extending radially from the outer periphery of the brace member 1 and the other end of the belt 2 wraps around a tubular object (not shown) and extends from a second end of the extension portion 11 and is located between the first end of the belt 2 and the screw 3. The positioning holes 21 are engaged with threads of the screw 3.

A driving member 4 has a receiving port 41 defined in a first end thereof and a ring is on a second end of the driving member 4. The receiving port 41 is composed of a recess 411 and an enlarged opening 410 defined in the end surface of the first end of the driving member 4.

An outer diameter of the first section 330 is larger than an outer diameter of the second section 331 and an inner diameter of the recess 411. The outer diameter of the second section 331 is larger than the inner diameter of the recess 411. As shown in FIGS. 3-5, the second section 331 of protrusion 33 is first inserted into the receiving port 41 and the periphery of the enlarged opening 410 is pushed outward by the first section 330 of the protrusion 33 of the screw 3 and the second section 331 is engaged with the recess 411. Along with the movement toward the receiving port 41, the second section 331 is completely embraced by the periphery of the recess 411 and the first section 330 of the protrusion 33 is engaged with the enlarged opening 410 of the driving member 4. By the engagement, the screw 3 is rotated when rotating the driving member 4 and the second end of the belt 2 is pulled away from the extension portion 11 to tighten the tubular object wrapped by the belt 2.

The shape of the protrusion 33 is simplified so that it is easily to be manufactured and the manufacturing cost is reduced. The driving member 4 is easily and securely connected to the protrusion 33 so that the users tighten the tubular objects conveniently.

While we have shown and described the embodiment in accordance with the present invention, it should be clear to those skilled in the art that further embodiments may be made without departing from the scope of the present invention.

What is claimed is:

1. A fastener comprising:
a brace member having a screw rotatably extending from one end of the brace member, the brace member having an extension portion, the screw having a shoulder portion extending radially outward therefrom and a protrusion extending from the shoulder portion, the protrusion including a first section and a second section which axially extends from the first section, the shoulder portion and the protrusion located outside of the brace member;
a belt having a plurality of positioning holes defined therethrough, one end of the belt extending through a first end of the extension portion and the other end of the belt extending from a second end of the extension portion and located between the first end of the belt and the screw, the positioning holes engaged with threads of the screw, and
a driving member having a receiving port which is composed of a recess and an enlarged opening defined in an end of the driving member, an outer diameter of the first section being larger than an outer diameter of the second section and an inner diameter of the recess, the outer diameter of the second section being larger than the inner diameter of the recess, the second section of protrusion being engaged with the recess and the first section of the protrusion being engaged with the enlarged opening of the driving member.

2. The fastener as claimed in claim 1, wherein the second section has a rectangular cross section.
